(19) United States
(12) Patent Application Publication
(10) Pub. No.: US 2012/0142267 A1
(43) Pub. Date: Jun. 7, 2012

(54) ANTENNA APPARATUS FOR MOBILE TERMINAL

(75) Inventor: Ki-Sung BAE, Gyeonggi-do (KR)

(73) Assignee: SAMSUNG ELECTRONICS CO., LTD., Gyeonggi-Do (KR)

(21) Appl. No.: 13/303,382

(22) Filed: Nov. 23, 2011

(30) Foreign Application Priority Data
Dec. 3, 2010 (KR) 10-2010-0122568

(51) Int. Cl. H04W 4/06

(52) U.S. Cl. 455/3.01

(57) ABSTRACT

An antenna apparatus of a mobile terminal is provided. The apparatus includes a bar antenna, a Digital Multimedia Broadcasting (DMB) module, an additional function module, a switching unit, and a controller. The Digital Multimedia Broadcasting module is selectively connected with the bar antenna to perform a Digital Multimedia Broadcasting function. The additional second function module is selectively connected with the bar antenna to perform an additional secondary function different than the Digital Multimedia Broadcasting function. The switching unit is installed on a feed of the bar antenna to perform a selective switching operation on the DMB module and the additional second function module. The controller controls the switching unit.

### CLAIM OF PRIORITY

This patent application claims priority to and the benefit under 35 U.S.C. §119(a) of a Korean patent application filed in the Korean Intellectual Property Office on Dec. 3, 2010 and assigned Serial No. 10-2010-0122568, the entire disclosure of which is hereby incorporated by reference.

### BACKGROUND OF THE INVENTION

1. Field of the Invention

The present invention is directed to an antenna apparatus of a mobile terminal. More particularly, the present invention is directed to an antenna apparatus of a mobile terminal that can contribute to a slim profile of the mobile terminal by using a Digital Multimedia Broadcasting (DMB) antenna for an additional function realized in the mobile terminal and in a dual purpose manner.

2. Description of the Related Art

Currently, with development of electronic communication industries, mobile terminals such as a mobile communication terminal, an electronic scheduler, a personal digital assistant, etc. have become indispensable to a modern society. These play an important role of transferring information and are changing and evolving rapidly. Under this circumstance, a mobile terminal provides additional functions, and has a lightweight slim profile.

As described above, it becomes even more difficult to mount lots of elements in a limited space under a circumstance where a mobile terminal has a lightweight slim profile and small housing. For example, an antenna space for radio wave transmission/reception has an excellent performance when the antenna space is large, but the space for mounting the antenna becomes narrow more and more small fitting.

Generally, a mobile terminal may have several antennas for transmitting/receiving signals in different frequency bands. For example, the mobile terminal has antennas each for Digital Multimedia Broadcasting communication, Bluetooth communication, Wi-Fi communication, and GPS communication, etc., respectively. At this point, it is difficult to mount all these antennas in a limited space and a small housing. Furthermore, since an antenna may interfere with other factors and so the performance of the antenna may be easily deteriorated, a mounting method considering this is essential.

### SUMMARY OF THE INVENTION

An aspect of the present invention is to address at least the above-mentioned problems and/or disadvantages and to provide at least the advantages described below. Accordingly, an aspect of the present invention is to provide an antenna apparatus of a mobile terminal that can contribute to a slim profile of the mobile terminal by using an antenna for performing a specific function as a sub-antenna for an additional function in the mobile terminal in a dual-purpose manner.

Another aspect of the present invention is to provide an antenna apparatus of a mobile terminal that does not require a separate antenna for short distance communication by using a Digital Multimedia Broadcasting antenna as an antenna for the short distance RF communication in a dual-purpose manner.

Still another aspect of the present invention is to provide an antenna apparatus of a mobile terminal, configured to improve a communication quality of the mobile terminal and contribute to a slim profile.

In accordance with a exemplary embodiment of the present invention, an antenna apparatus of a mobile terminal is provided. The apparatus includes a bar antenna, and a Digital Multimedia Broadcasting (DMB) module selectively connected with the bar antenna. The module is for performing a Digital Multimedia Broadcasting function, and an additional function module is selectively connected with the bar antenna, and for performing an additional function. The mobile device also has a switching unit installed on a feed of the bar antenna, and for performing a selective switching operation on the Digital Multimedia Broadcasting module. The mobile apparatus also has additional function module, and a controller that controls the switching unit.

In accordance with another exemplary embodiment of the present disclosure, an antenna apparatus of a mobile terminal is provided. The apparatus includes a movable bar antenna, and a main board having a terminal of a Digital Multimedia Broadcasting (DMB) module. The module performs a Digital Multimedia Broadcasting function, and a terminal of an additional function module performs an additional function. The module also includes that when the bar antenna moves to contact the terminal of the DMB module, the module receives a signal in a DMB band, and when it moves to contact the terminal of the additional function module, the module transmits/receives a signal in a band of the additional function.

In accordance with another exemplary embodiment of the present disclosure, a portable terminal includes: an antenna; a Digital Multimedia Broadcasting (DMB) module selectively coupled to the antenna; an additional second function module; a switching circuit for performing a selective switching between the Digital Multimedia Broadcasting module and the additional second function module; and a controller for controlling the switching circuit.

Other aspects, advantages and features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings in which:

FIG. 1 is a perspective view illustrating a mobile terminal having an antenna apparatus for Digital Multimedia Broadcasting according to an exemplary embodiment of the present disclosure;

FIG. 2 is a block diagram illustrating a mobile terminal that uses an antenna apparatus for Digital Multimedia Broadcasting as a sub-antenna apparatus for an additional function according to an exemplary embodiment of the present disclosure;

FIG. 3 is a view illustrating that an antenna apparatus for Digital Multimedia Broadcasting is used as a sub-antenna apparatus for an additional function depending on a user's terminal environment according to an exemplary embodiment of the present disclosure; and

FIGS. 4A and 4B are views illustrating that an antenna apparatus for Digital Multimedia Broadcasting mechanically contacts a terminal of a relevant module for a Digital Multimedia Broadcasting function or an additional function as the antenna apparatus for Digital Multimedia Broadcasting module moves according to an exemplary embodiment of the present invention.

Throughout the drawings, like reference numerals will be understood to refer to like parts, components and structures.

### DETAILED DESCRIPTION

The following description with reference to the accompanying drawings is provided to assist in a comprehensive understanding of exemplary embodiments of the present disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, and are merely used to enable a clear and consistent understanding of the present disclosure. Accordingly, it should be apparent to those skilled in the art that the following description of exemplary embodiments of the present disclosure are provided for illustration purpose only and not for the purpose of limiting the invention as defined by the appended claims and their equivalents.

Exemplary embodiments of the present disclosure provide an antenna apparatus that can contribute to a slim profile of a mobile terminal by using the conventional antenna for receiving Digital Multimedia Broadcasting without separately having an antenna for performing an additional function such as GPS communication, Bluetooth communication, Wi-Fi communication, etc.

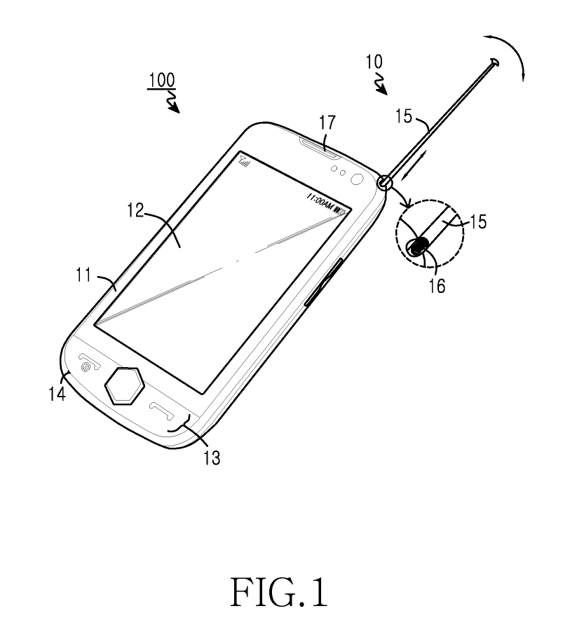

FIG. 1 is a perspective view illustrating a mobile terminal having an antenna apparatus for Digital Multimedia Broadcasting according to an exemplary embodiment of the present disclosure.

Referring to FIG. 1, the mobile terminal 100 includes a body 11 forming a slim appearance, and a plurality of elements contained within the body 11. The mobile terminal 100 includes a display 12 for outputting an image, and a speaker 17 for outputting a voice signal, and a microphone 14 for receiving a voice signal, the mobile terminal 100 also includes a key button 13 serving as a data input unit. The display 12 may be a Liquid Crystal Display (LCD) having a plurality of pixels. When a touch screen is applied to the LCD, the display 12 may perform a data input function as an auxiliary unit relative to the keys or in substitution for the keys.

The mobile terminal 100 includes a main antenna apparatus (not shown) or transceiver and for transmitting/receiving a signal in a relevant frequency band for communication, and an antenna apparatus 10 for receiving a Digital Multimedia Broadcasting and a signal of an additional function. The antenna apparatus 10 includes a bar antenna 15 that may extend outside of the mobile terminal.

The bar antenna 15 may freely extend/contract by sequentially several telescoping or overlapping metal pipes having different diameters. The bar antenna 15 may be replaced by a whip antenna in an alternative embodiment.

In addition, the mobile terminal 100 may perform an additional function such as Bluetooth communication, GPS communication, and/or Wi-Fi communication, etc. However, an antenna apparatus for the additional second function does not exist because the antenna apparatus 10 is used for the additional function in a dual-purpose manner.

The bar antenna 15 has a Digital Multimedia Broadcasting resonance frequency and a resonance frequency for the additional second function. The bar antenna 15 moves to the inside or the outside of the mobile terminal, which may be a cause that deteriorates the performance of the bar antenna 15. In addition, the bar antenna 15 may have an unmatching resonance frequency. Therefore, the antenna apparatus 10 may further include a matching unit. The matching unit or module is for compensating for the unmatching resonance frequency of the bar antenna 15 and improving the performance thereof. The matching unit may be a matching circuit configured in a main circuit board. Alternatively, according to an exemplary embodiment of the present disclosure, the matching unit may be a separate radiator element 16 configured inside the bar antenna 15. The radiator 16 may be a coil antenna or a helical antenna 16. The radiator 16 moves and is supplied with electricity together with the bar antenna 15.

The radiator 16 may be used for the purpose of compensating for an unmatching resonance frequency of a relevant antenna caused by interference. For example, in one non-limiting embodiment, the bar antenna 15 may not obtain a predetermined resonance frequency due to interference of the main antenna or one or more components. At this point, the radiator 16 may be controlled to the predetermined resonance frequency of the bar antenna 15.

Furthermore, the radiator 16 may contribute to a predetermined resonance frequency formation of a signal. For example, the bar antenna 15 and the radiator 16 mutually may emit a signal to resonate to have a Digital Multimedia Broadcasting resonance frequency, and a resonance frequency for an additional second function, and other predetermined resonance frequencies.

The mobile terminal 100 includes a Digital Multimedia Broadcasting module for a Digital Multimedia Broadcasting function, and an additional function module for an additional second function. The mobile terminal 100 may selectively connect the bar antenna 15 to a relevant module within the mobile terminal 100.

For example, the bar antenna 15 may be connected to a module selected under a user's predetermined terminal environment. When the user executes a Digital Multimedia Broadcasting function, the bar antenna 15 is connected with the Digital Multimedia Broadcasting module. In addition, when the user executes an additional second function, the bar antenna 15 is connected with the additional second function module. Furthermore, when the user executes both the Digital Multimedia Broadcasting function and the additional second function, the bar antenna 15 is connected to both the two modules.

For another example, the bar antenna 15 may be connected with a relevant module as it moves. Generally, to swiftly execute the Digital Multimedia Broadcasting function, the bar antenna 15 should extend to the outside of the mobile terminal. When the bar antenna 15 is inserted into the inside of the mobile terminal while the Digital Multimedia Broadcasting function is executed, a signal strength may be weakened. For an additional function such as Bluetooth communication to quickly operate, the bar antenna 15 should not extend to the outside. Therefore, according to an exemplary embodiment of the present disclosure, the bar antenna 15 may be connected with the Digital Multimedia Broadcasting module when extending outside, and may be connected with the additional function module when inserted inside of the mobile terminal 100. In addition, according to an exemplary embodiment of the present disclosure, the bar antenna 15 may be connected with the Digital Multimedia Broadcasting module and the additional second function module when extending outside, and may be connected with the additional second function module when inserted into the inside of the mobile terminal 100. At this point, a relevant module and the bar antenna 15 are only mutually connected as the bar antenna 15 moves, and a relevant function may not be executed.

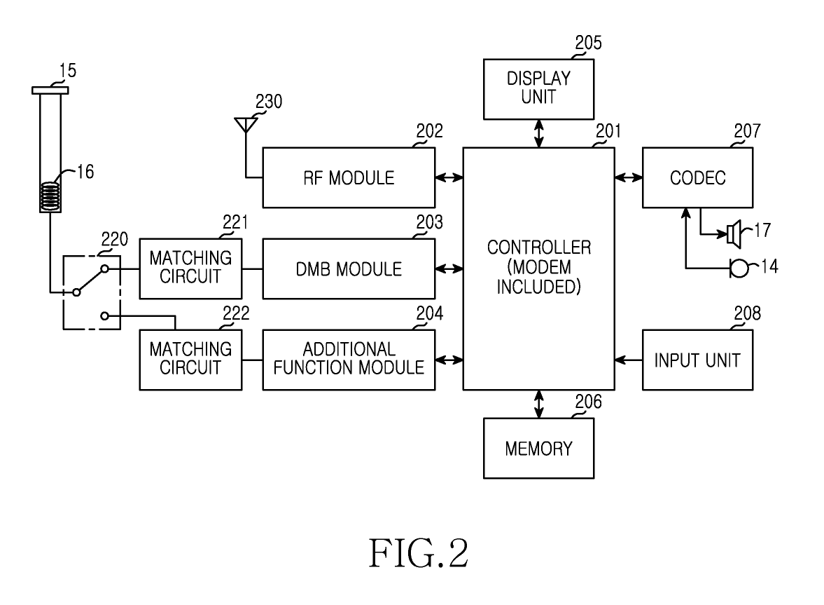

FIG. 2 is a block diagram illustrating a mobile terminal that uses an antenna apparatus for Digital Multimedia Broadcasting as a sub-antenna apparatus for an additional function according to an exemplary embodiment of the present disclosure.

Referring to FIG. 2, the controller 201 includes a modem for processing transmission/reception signals of modules 202, 203, and 204 described below. The modules 202, 203, and 204 may be one Radio Frequency (RF) module and may be realized to individually process each antenna.

The main antenna 230 is electrically connected to the RF module 202 to transmit/receive a signal in a frequency band for wireless communication.

The bar antenna 15 according to an exemplary embodiment of the present disclosure is electrically switched to a Digital Multimedia Broadcasting module 203 or an additional function module 204 by a predetermined switching unit 220. The switching unit 220 is controlled by the controller 201. Both the Digital Multimedia Broadcasting module 203 and the additional function module 204 are configured to be selectively provided with electricity with the above described bar antenna 15. Therefore, the switching unit 220 is configured to connect to a feed of the bar antenna 15.

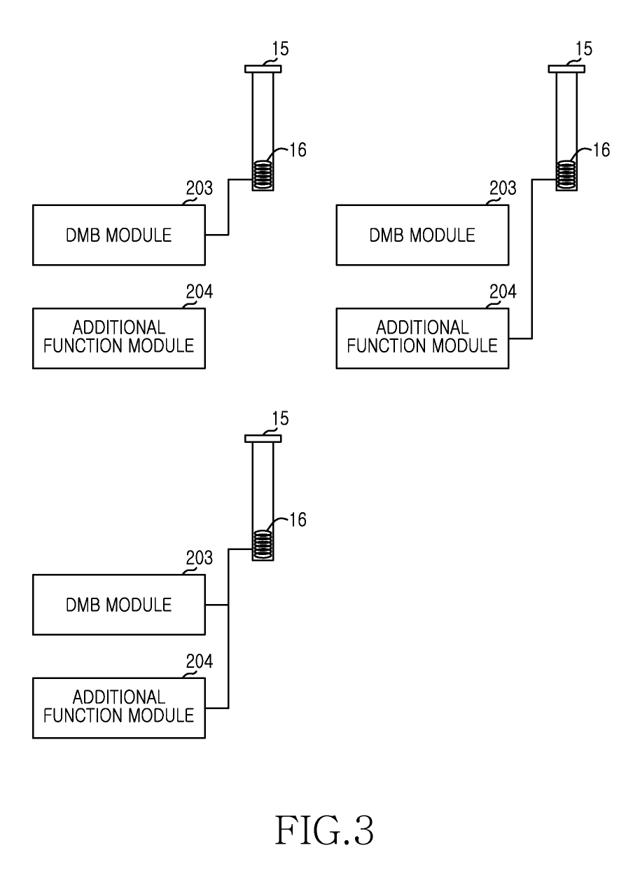

The controller 201 may control the switching unit 220 depending on a user's terminal use environment. FIG. 3 is a view illustrating that an antenna apparatus for Digital Multimedia Broadcasting utilized as a sub-antenna apparatus for an additional function depending on a user's terminal environment according to an exemplary embodiment of the present disclosure.

Referring to FIG. 3, when the terminal executes a Digital Multimedia Broadcasting function, the controller 201 may control the switching unit 220 so that the bar antenna 15 may be connected with the Digital Multimedia Broadcasting module 203. In addition, when the terminal executes an additional function, the controller 201 may control the switching unit 220 so that the bar antenna 15 may be connected with the additional second function module 204. Furthermore, when the terminal executes both the Digital Multimedia Broadcasting function and the second additional function, the controller 201 may control the switching unit 220 so that the bar antenna 15 may be connected to the two modules 203 and 204.

The terminal may further have the above-described radiator 16 to improve the performance of the bar antenna 15. In addition, to improve the performance of the bar antenna 15, the terminal may allow matching circuits 221 and 222 to intervene between the switching unit 220 and the Digital Multimedia Broadcasting module, or alternatively between the switching unit 220 and the additional second function module. The matching circuits 221 and 222 may include devices such as an inductor, or a capacitor, or other electrical component etc.

Since a display unit 205, a memory 206, a codec 207, an input unit 208 and a microphone 17, and a speaker 14 are known elements of the mobile terminal, descriptions thereof are omitted.

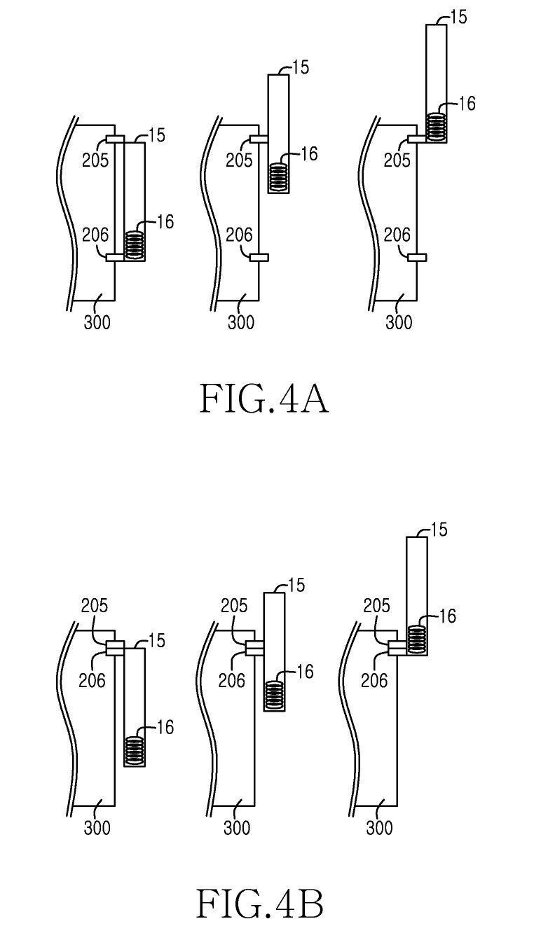

FIGS. 4A and 4B are views illustrating that a Digital Multimedia Broadcasting antenna mechanically contacts a terminal of a relevant module for a Digital Multimedia Broadcasting function or an additional second function as the Digital Multimedia Broadcasting antenna moves according to an exemplary embodiment of the present disclosure. A main board has terminals 205 and 206 of respective modules 203 and 204. The first terminal 205 is a terminal of the Digital Multimedia Broadcasting module 203, and the second terminal 206 is a terminal of the additional function module 204.

Referring to FIG. 4A, when inserted into the inside of the mobile terminal, the bar antenna 15 contacts the second terminal 206 and is connected with the addition second function module 204. When protruded to the outside of the mobile terminal 100, the bar antenna 15 contacts the first terminal 205 and is connected with the Digital Multimedia Broadcasting module 203. Referring to FIG. 4B, when inserted into the inside of the mobile terminal, the bar antenna 15 contacts the second terminal 206 and is connected with the addition second function module 204. When protruded to the outside of the mobile terminal, the bar antenna 15 contacts the two terminals 205 and 206 and is connected with the two modules 203 and 204. Generally, the Digital Multimedia Broadcasting function is performed when the bar antenna 15 is extended, which is illustrated by the previous embodiment. In addition, as described above, a relevant module and the bar antenna 15 are only mutually connected and a relevant function may not be executed.

In FIG. 3, when the bar antenna 15 is inserted into the inside of the mobile terminal even when the Digital Multimedia Broadcasting function is executed and the Digital Multimedia Broadcasting module 203 is connected with the bar antenna 15, a signal strength of the terminal 100 may be weak for wireless communication. In addition, even when the additional second function is executed and the additional second function module 204 is connected with the bar antenna 15, a signal strength may be weak for wireless communication as the bar antenna 15 moves. At this weak signal strength, the matching circuits 221 and 222 or the radiator 16 may improve operation.

In FIG. 4A, when the bar antenna 15 is not extended to the outside of the mobile terminal even when the Digital Multimedia Broadcasting function is executed, the Digital Multimedia Broadcasting module 203 cannot operate in a rapid manner. In addition, when the bar antenna 15 is not inserted into the inside of the mobile terminal even when the addition function is executed, the additional function module 204 cannot operate rapidly.

In FIG. 4B, when the bar antenna 15 is not extended to the outside of the mobile terminal even when the Digital Multimedia Broadcasting function is executed, the Digital Multimedia Broadcasting module 203 cannot operate rapidly. The additional function may be always executed regardless of movement of the bar antenna 15, and a weakened signal may be improved by the matching circuit 222 or the radiator 16 of the terminal 100.

Consequently, since the antenna apparatus according to an exemplary embodiment of the present disclosure uses a Digital Multimedia Broadcasting antenna as an antenna for an additional second function in a dual purpose manner, it may contribute to a slim profile of the mobile terminal.

Although the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

What is claimed is:

1. An antenna apparatus of a mobile terminal, the apparatus comprising:
a bar antenna;
a Digital Multimedia Broadcasting (DMB) module selectively connected with the bar antenna, wherein the Digital Multimedia Broadcasting is for performing a Digital Multimedia Broadcasting function;
an additional second function module being selectively connected to the bar antenna, wherein the second functional module is for performing an additional second function;
a switching circuit installed on a feed of the bar antenna, wherein the switching circuit is for performing a selective switching operation on the Digital Multimedia Broadcasting module and the additional second function module; and
a controller for controlling the switching circuit.

2. The apparatus of claim 1, further comprising a matching circuit for compensating for an unmatching resonance frequency.

3. The apparatus of claim 2, wherein the matching circuit comprises a radiator element being configured inside the bar antenna.

4. The apparatus of claim 3, wherein the radiator element comprises one of a coil antenna and a helical antenna.

5. The apparatus of claim 2, wherein the matching circuit is connected to the Digital Multimedia Broadcasting module or the additional second function module.

6. The apparatus of claim 1, wherein a function processed by the additional second function module comprises one of Bluetooth communication, Wi-Fi communication, and Global Positioning System (GPS) communication.

7. The apparatus of claim 1, wherein the bar antenna is movable between an inside or an outside of the mobile terminal.

8. An antenna apparatus of a mobile terminal, the apparatus comprising:
a movable bar antenna; and
a main circuit board having a first terminal of a Digital Multimedia Broadcasting module performing a DMB function, and a second terminal of an additional second function module performing an additional second function,
wherein when the bar antenna moves to contact the first terminal of the Digital Multimedia Broadcasting module, the bar antenna receives a signal in a DMB band, and when the bar antenna moves to contact the second terminal of the second additional function module, the bar antenna transmits/receives a signal in a band of the additional second function.

9. The apparatus of claim 8, further comprising a matching circuit for compensating for an unmatching resonance frequency.

10. The apparatus of claim 9, wherein the matching circuit comprises a radiator element.

11. The apparatus of claim 10, wherein the radiator element comprises one of a coil antenna and a helical antenna.

12. The apparatus of claim 9, wherein the matching circuit is connected to the Digital Multimedia Broadcasting module or the additional function second module.

13. The apparatus of claim 8, wherein a function processed by the additional second function module comprises one of Bluetooth communication, Wi-Fi communication, and Global Positioning System (GPS) communication.

14. A portable terminal comprising:
an antenna;
a Digital Multimedia Broadcasting (DMB) module selectively coupled to the antenna;
an additional second function module;
a switching circuit for performing a selective switching between the Digital Multimedia Broadcasting module and the additional second function module; and
a controller for controlling the switching circuit.

15. The terminal of claim 14, further comprising a matching circuit for compensating for an unmatching resonance frequency.

16. The terminal of claim 15, wherein the matching circuit comprises a radiator element.

17. The terminal of claim 16, wherein the radiator element comprises one of a coil antenna and a helical antenna.

18. The terminal of claim 16, wherein the matching circuit is connected to the Digital Multimedia Broadcasting module or the additional function second module.

19. The terminal of claim 14, wherein the second function processed by the additional function module comprises one of Bluetooth communication, Wi-Fi communication, and Global Positioning System (GPS) communication.
